(19) United States
(12) Patent Application Publication
(10) Pub. No.: US 2022/0215333 A1
(43) Pub. Date: Jul. 7, 2022

(54) APP Management System for Identifying Storage Boxes and Method Using the APP Management System

(71) Applicant: Kuo-Chin Chiang, Taichung City (TW)

(72) Inventor: Kuo-Chin Chiang, Taichung City (TW)

(21) Appl. No.: 17/142,279

(22) Filed: Jan. 6, 2021

(51) Int. Cl. G06Q 10/08; G06F 21/44; G06K 19/07; G06F 9/54

(52) U.S. Cl. CPC G06Q 10/087; G06F 9/547; G06K 19/0723; G06F 21/44

(57) ABSTRACT

An APP management system includes a front-end APP management unit, and a back-end website management unit. A management method using the APP management system includes downloading an APP program by a mobile apparatus, inputting an authorization key previously through the back-end website management unit, deriving the authorization key of using the APP program through the front-end APP management unit, verifying the authorization key, building an information of the storage boxes, scanning the NFC tag of each of the storage boxes by the storage box bundling module, taking a picture of the items of each of the storage boxes by the mobile apparatus, bundling the NFC tag and the picture, and finishing a filing work of the storage boxes.

### BACKGROUND OF THE INVENTION

### 1. Field of the Invention

The present invention relates to a management system and a method using the management system and, more particularly, to an APP management method for processing and identifying storage boxes.

### 2. Description of the Related Art

A storage box is used for placing various articles or tools to facilitate the user carrying and storing the articles or tools. When multiple storage boxes are stacked together, it is difficult to identify the articles or tools contained in each of the storage boxes. Marks or labels are attached to the outside of each of the storage boxes to facilitate the user identifying the articles or tools contained in each of the storage boxes. However, when the articles or tools have large numbers and specifications, it is difficult for the user to search for and find the articles or tools contained in each of the storage boxes, thereby causing inconvenience to the user, and thereby wasting the time and manual labor.

### BRIEF SUMMARY OF THE INVENTION

The primary objective of the present invention is to provide an APP management system that has a smart managing function to locate the storage box exactly, so that the user searches for and finds the storage box easily, quickly and conveniently, thereby saving the time and manual labor.

In accordance with the present invention, there is provided a management method using an APP management system. The APP management system comprises a front-end APP management unit, a back-end website management unit, a plurality of storage boxes, and at least one mobile apparatus. Each of the storage boxes contains multiple items therein. Each of the storage boxes is provided with a near-field communication (NFC) tag.

The management method comprises:

downloading an APP program by the at least one mobile apparatus;

inputting an authorization key previously through the back-end website management unit;

registering;

deriving the authorization key of using the APP program through the front-end APP management unit;

inputting the authorization key;

verifying the authorization key;

starting the APP program;

entering and building an information of the storage boxes;

entering a storage box bundling module;

scanning the NFC tag of each of the storage boxes by the storage box bundling module;

taking a picture of the items of each of the storage boxes by the at least one mobile apparatus;

bundling the NFC tag and the picture of the items of each of the storage boxes;

finishing a filing work of the storage boxes;

scanning the NFC tag of each of the storage boxes by the at least one mobile apparatus;

transmitting the picture of the items of each of the storage boxes to the at least one mobile apparatus by the NFC tag; and

checking the items of each of the storage boxes by the at least one mobile apparatus.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a block diagram of a back-end website management unit of a management system in accordance with the preferred embodiment of the present invention.

FIG. 2 is another block diagram of the back-end website management unit of the management system in accordance with the preferred embodiment of the present invention.

FIG. 3 is a schematic view showing usage of a company management module of the back-end website management unit in accordance with the preferred embodiment of the present invention.

FIG. 4 is a schematic view showing usage of a storage box management module of the back-end website management unit in accordance with the preferred embodiment of the present invention.

FIG. 5 is a schematic view showing usage of an authorization key management module of the back-end website management unit in accordance with the preferred embodiment of the present invention.

FIG. 6 is a perspective view showing multiple storage boxes in accordance with the preferred embodiment of the present invention.

FIG. 7 is a perspective view showing a mobile apparatus in accordance with the preferred embodiment of the present invention.

FIG. 8 is a flow chart showing usage of the management system in accordance with the preferred embodiment of the present invention.

FIG. 9 is a schematic operational view showing usage of a storage box bundling module of the management system in accordance with the preferred embodiment of the present invention.

FIG. 10 is a schematic operational view showing the mobile apparatus scanning the NFC tag of each of the storage boxes and getting a picture of the items of each of the storage boxes.

FIG. 11 is a perspective view of a storage box in accordance with another preferred embodiment of the present invention.

### DETAILED DESCRIPTION OF THE INVENTION

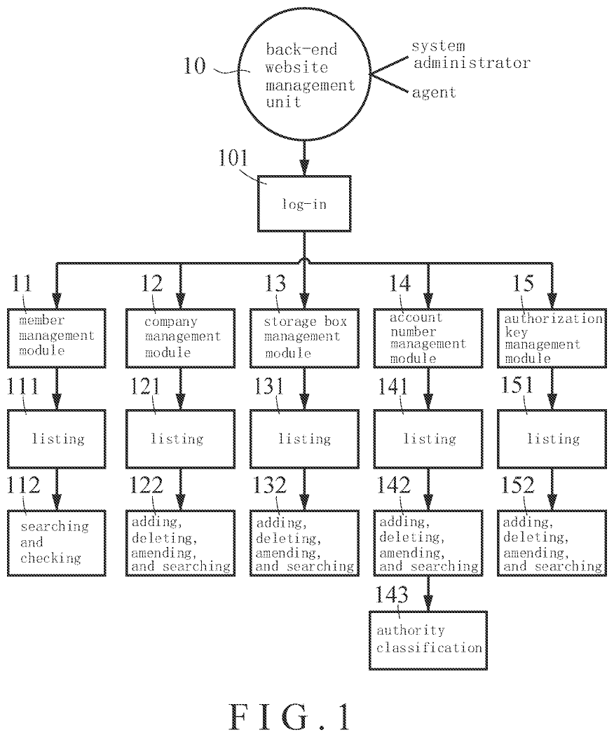

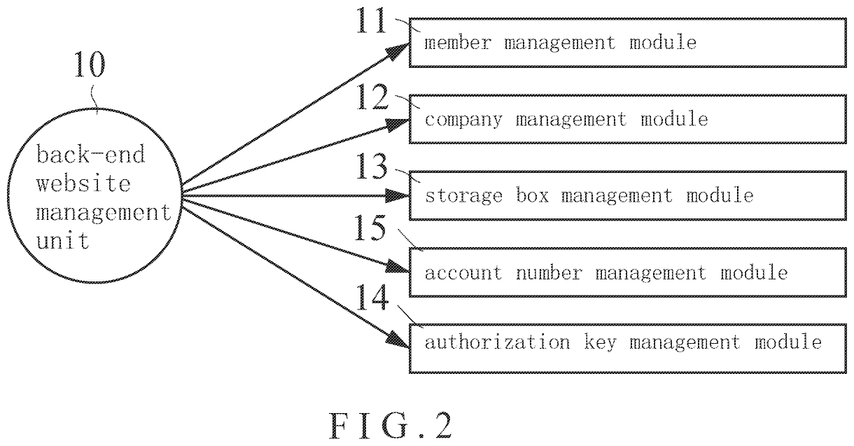

Referring to the drawings and initially to FIGS. 1-10, an APP management system in accordance with the preferred embodiment of the present invention comprises a front-end APP (application, application program, application software or mobile application) management unit, a back-end website management unit 10, a plurality of storage boxes 20, and at least one mobile apparatus 40.

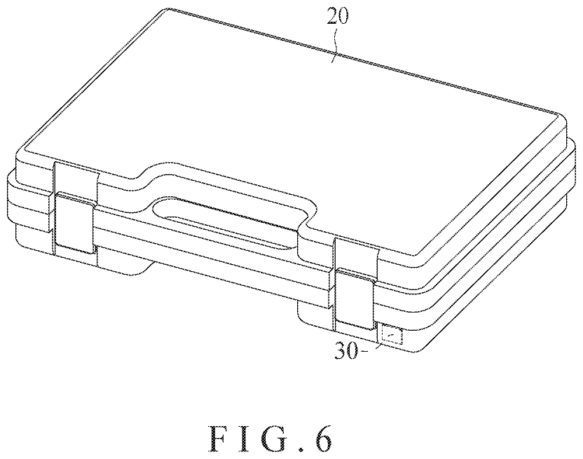

As shown in FIG. 6, the storage boxes 20 stack together. Each of the storage boxes 20 contains multiple items (or articles or contents or tools) 21 therein. Each of the storage boxes 20 is provided with a near-field communication (NFC) tag 30. Preferably, each of the storage boxes 20 is integrally formed with the NFC tag 30 which is located at a sandwiched portion (or mezzanine) between an inside and an outside of each of the storage boxes 20. Alternatively, the NFC tag 30 is stuck to an interior or an exterior of each of the storage boxes 20. The NFC tag 30 has an identification code.

The front-end APP management unit includes an APP API (application programming interface), an Android version, and an IOS (i-phone operating system) version. The APP API includes an APP program. In practice, the front-end APP management unit is accessible through a log-in (or sign-in), with an accessible authority (or permission) of a member.

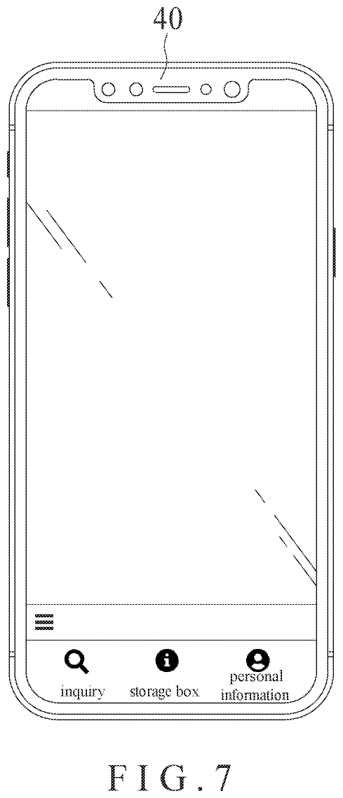

As shown in FIG. 7, the at least one mobile apparatus 40 is a smart phone or cell phone. The at least one mobile apparatus 40 downloads the APP program of the APP API. The APP program of the APP API has functions, including inquiry, information of the storage boxes 20, personal information, etc.

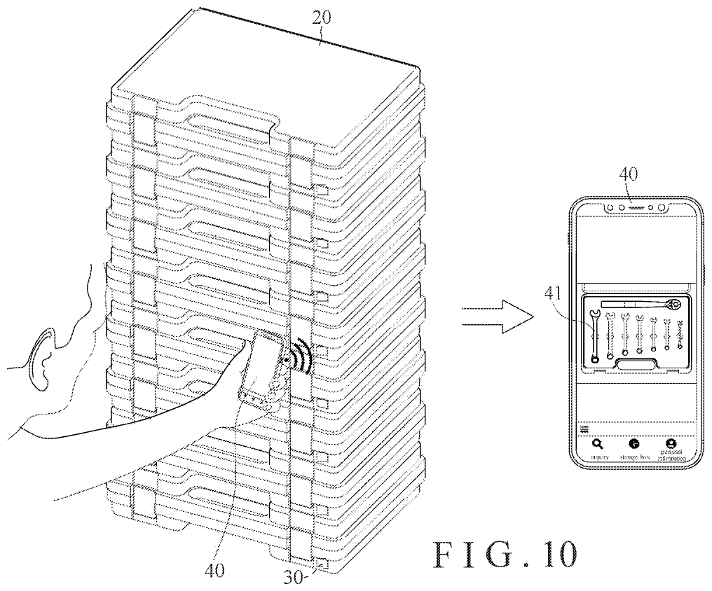

In practice, the NFC tag 30 transmits wirelessly a signal of the identification code to the at least one mobile apparatus 40 to form a communication therebetween, so that the at least one mobile apparatus 40 receives the picture 41 (see FIG. 10) of the items 21 of each of the storage boxes 20 in a short distance. Thus, the at least one mobile apparatus 40 checks and inspects the picture 41 of the items 21 of each of the storage boxes 20 through the signal of the identification code of the NFC tag 30.

The back-end website management unit 10 is accessible through a log-in (or sign-in) 101, with an accessible authority (or permission) of a system administrator and an agent. The back-end website management unit 10 includes a member management module 11 for editing, inquiry, authorization, and confirmation of a member built-in management work, a company management module 12 for editing and inquiry of a company management work, a storage box management module 13 for editing and inquiry of a storage box management work, an account number management module 14 for editing and inquiry of a user management work, and an authorization key management module 15 for editing and inquiry of an authorization key management work.

The member management module 11 includes and serially enters a page 111 of listing and a page 112 of searching and checking (or reviewing).

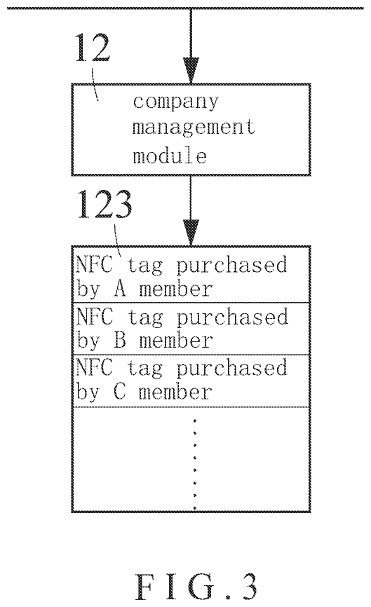

The company management module 12 includes and serially enters a page 121 of listing and a page 122 of adding, deleting, amending, and searching. Thus, the company management module 12 is used for managing an indication page 123 as shown in FIG. 3. The indication page 123 indicates the number of the NFC tags 30 purchased respectively by A member, B member, C member, etc.

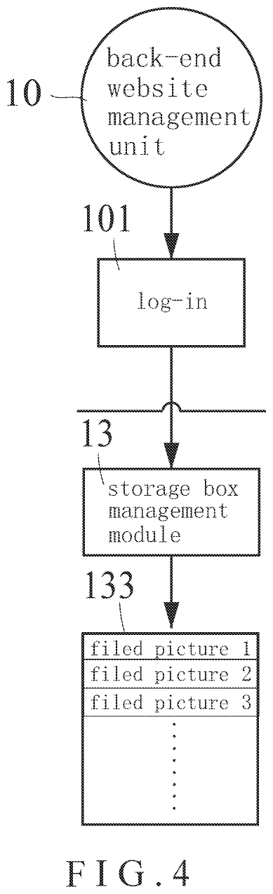

The storage box management module 13 includes and serially enters a page 131 of listing and a page 132 of adding, deleting, amending, and searching. Thus, the storage box management module 13 is used for managing an indication page 133 as shown in FIG. 4. The indication page 133 indicates filed pictures 1, 2, 3, etc.

The account number management module 14 includes and serially enters a page 141 of listing, a page 142 of adding, deleting, amending, and searching, and a page 143 of authority classification (or division).

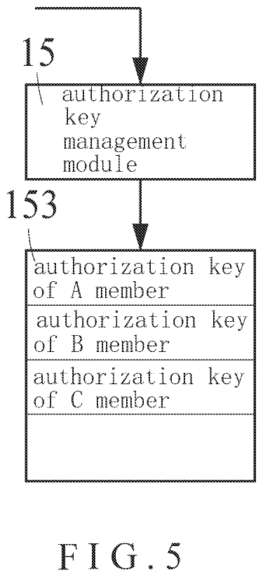

The authorization key management module 15 includes and serially enters a page 151 of listing and a page 152 of adding, deleting, amending, and searching. Thus, the authorization key management module 15 is used for managing an indication page 153 as shown in FIG. 5. The indication page 153 indicates the authorization key of A member, B member, C member, etc.

It is appreciated that, the front-end part is a presentation of the website, that is, the web screen viewed by the users of the Internet. Thus, the web pages explored by the users of the Internet belong to the front-end of the website, including texts, characters, pictures, animation effects, etc. The web page designer is responsible for design of the front-end part. The rear-end part is used for updating and maintenance of the web pages. The rear-end part edits and amends the information contents of the front-end part. The web page engineer is responsible for design of the operation interface of the rear-end part, including amending the words of a company introduction, uploading the album photos, changing the product pictures, managing the member information, checking the customer orders, etc. Therefore, the rear-end part is also called a content management system which is specially designed to facilitate the customers managing the website contents. In short, the front-end of the website is used for the Internet users, and the rear-end of the website is used for maintenance of the contents of the website.

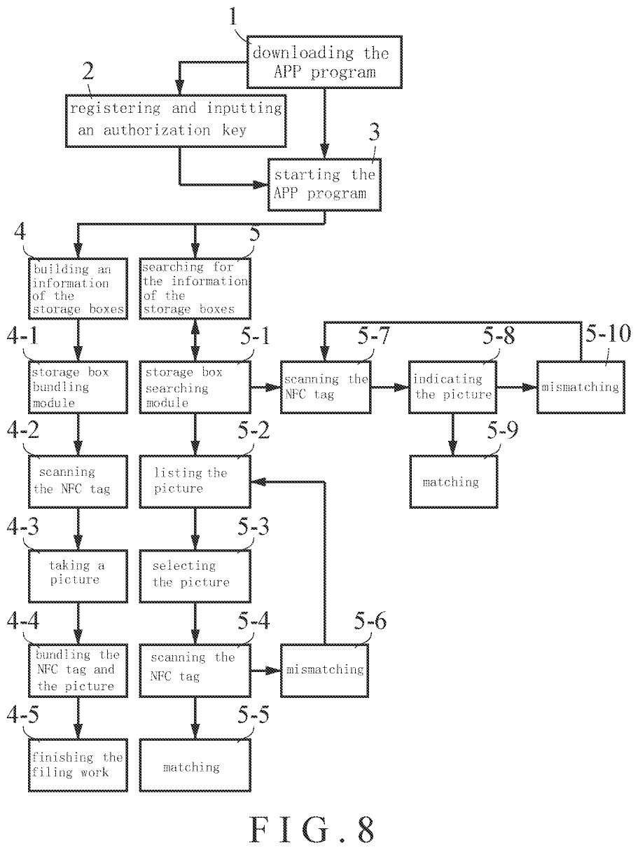

With reference to FIGS. 8-10, the APP management system in accordance with the preferred embodiment of the present invention has an APP management method comprising the following steps:

a step 1 of the at least one mobile apparatus 40 downloading the APP program of the APP API;

a step 2 of registering and inputting an authorization key;

a step 3 of starting the APP program to log-in;

a step 4 of building (or filing) an information of the storage boxes 20;

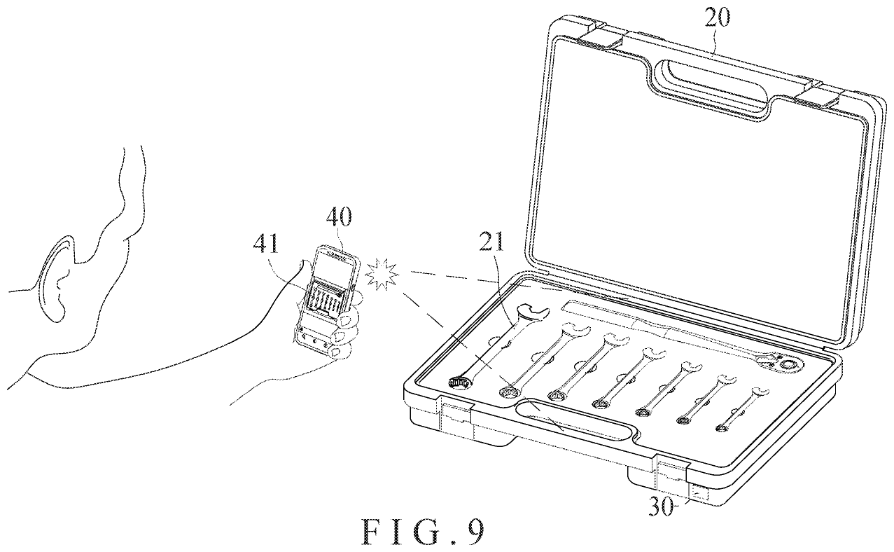

a step 4-1 of entering a storage box bundling (or binding or tying) module as shown in FIG. 9;

a step 4-2 of scanning the NFC tag 30 of each of the storage boxes 20 as shown in FIG. 10;

a step 4-3 of taking a picture 41 of the items 21 of each of the storage boxes 20;

a step 4-4 of bundling (or binding or tying) the NFC tag 30 and the picture 41 of the items 21 of each of the storage boxes 20;

a step 4-5 of finishing a filing (or built-in or documenting) work of the storage boxes 20;

a step 5 of searching for the information of the storage boxes 20;

a step 5-1 of entering a storage box searching module;

a step 5-2 of listing the picture 41 or a step 5-7 of scanning the NFC tag 30;

the step 5-2 of listing the picture 41 including listing the picture;

a step 5-3 of selecting the picture 41;

a step 5-4 of scanning the NFC tag 30;

a step 5-5 of matching or a step 5-6 of mismatching, and returning to the step 5-2 of listing the picture 41 when mismatching;

the step 5-7 of scanning the NFC tag 30 including scanning the NFC tag 30;

a step 5-8 of indicating the picture 41;

a step 5-9 of matching or a step 5-10 of mismatching, and returning to the step 5-7 of scanning the NFC tag 30 when mismatching.

In the step 4-1 of entering a storage box bundling module, the enterprise identifies the registered user from the data base after the customer finishes the storage box bundling work, so as to provide a personal service for processing the storage box. In the step 4-4 of bundling the NFC tag 30 and the picture 41, the NFC tag 30 and the picture 41 are bundled after the step 4-2 of scanning the NFC tag 30 and the step 4-3 of taking a picture 41 of the items 21 are finished.

In conclusion, an APP management method for processing and identifying storage boxes comprises:

downloading an APP program by the at least one mobile apparatus 40;

inputting an authorization key previously through the back-end website management unit 10;

registering;

deriving the authorization key of using the APP program through the front-end APP management unit;

inputting the authorization key;

verifying the authorization key;

starting the APP program to log-in;

entering and building an information of the storage boxes 20;

entering a storage box bundling module;

scanning the NFC tag 30 of each of the storage boxes 20 by the storage box bundling module;

taking a picture 41 of the items 21 of each of the storage boxes 20 by the at least one mobile apparatus 40;

bundling the NFC tag 30 and the picture 41 of the items 21 of each of the storage boxes 20;

finishing a filing work of the storage boxes 20;

scanning the NFC tag 30 of each of the storage boxes 20 by the at least one mobile apparatus 40;

transmitting the picture 41 of the items 21 of each of the storage boxes 20 to the at least one mobile apparatus 40 by the NFC tag 30; and

checking the items 21 of each of the storage boxes 20 by the at least one mobile apparatus 40.

The step of starting the APP program to log-in includes:

searching for the information of the storage boxes 20;

entering a storage box searching module;

listing the picture 41 or scanning the NFC tag 30;

the step of listing the picture 41 including listing the picture;

selecting the picture 41;

scanning the NFC tag 30;

matching or mismatching, and returning to the step of listing the picture 41 when mismatching;

the step of scanning the NFC tag 30 including scanning the NFC tag 30;

indicating the picture 41; and

matching or mismatching, and returning to the step of scanning the NFC tag 30 when mismatching.

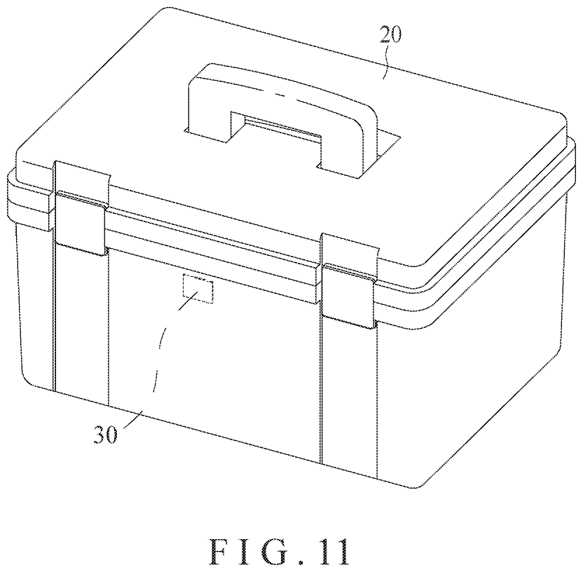

Referring to FIG. 11, the NFC tag 30 is located at the middle position of the storage box 20.

Accordingly, the APP management system has a smart managing function to locate the storage box exactly, so that the user searches for and finds the storage box easily, quickly and conveniently, thereby saving the time and manual labor.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A management method using an APP management system, comprising a front-end APP management unit, a back-end website management unit, a plurality of storage boxes, and at least one mobile apparatus, each of the storage boxes containing multiple items therein, each of the storage boxes provided with a near-field communication (NFC) tag;
the management method comprising:
downloading an APP program by the at least one mobile apparatus;
inputting an authorization key previously through the back-end website management unit;
registering;
deriving the authorization key of using the APP program through the front-end APP management unit;
inputting the authorization key;
verifying the authorization key;
starting the APP program;
entering and building an information of the storage boxes;
entering a storage box bundling module;
scanning the NFC tag of each of the storage boxes by the storage box bundling module;
taking a picture of the items of each of the storage boxes by the at least one mobile apparatus;
bundling the NFC tag and the picture of the items of each of the storage boxes;
finishing a filing work of the storage boxes;
scanning the NFC tag of each of the storage boxes by the at least one mobile apparatus;
transmitting the picture of the items of each of the storage boxes to the at least one mobile apparatus by the NFC tag; and
checking the items of each of the storage boxes by the at least one mobile apparatus.

2. The management method as claimed in claim 1, wherein the at least one mobile apparatus is a smart phone or cell phone.

3. The management method as claimed in claim 1, wherein each of the storage boxes is integrally formed with the NFC tag which is located at a sandwiched portion between an inside and an outside of each of the storage boxes.

4. The management method as claimed in claim 1, wherein the NFC tag is stuck to an interior of each of the storage boxes.

5. The management method as claimed in claim 1, wherein the NFC tag is stuck to an exterior of each of the storage boxes.

6. The management method as claimed in claim 1, wherein:
the front-end APP management unit includes an APP API (application programming interface), an Android version, and an IOS (i-phone operating system) version;
the APP API includes the APP program; and
the front-end APP management unit is accessible through a log-in, with an accessible authority of a member.

7. The management method as claimed in claim 1, wherein the back-end website management unit is accessible through a log-in, with an accessible authority of a system administrator and an agent.

8. The management method as claimed in claim 1, wherein the back-end website management unit includes a member management module for editing, inquiry, authorization, and confirmation of a member built-in management work.

9. The management method as claimed in claim 1, wherein the back-end website management unit includes a company management module for editing and inquiry of a company management work.

10. The management method as claimed in claim 1, wherein the back-end website management unit includes a storage box management module for editing and inquiry of a storage box management work.

11. The management method as claimed in claim 1, wherein the back-end website management unit includes an account number management module for editing and inquiry of a user management work.

12. The management method as claimed in claim 1, wherein the back-end website management unit includes an authorization key management module for editing and inquiry of an authorization key management work.

13. The management method as claimed in claim 1, wherein the step of starting the APP program includes:
searching for the information of the storage boxes;
entering a storage box searching module;
listing the picture or scanning the NFC tag;
the step of listing the picture including listing the picture;
selecting the picture;
scanning the NFC tag;
matching or mismatching, and returning to the step of listing the picture when mismatching;
the step of scanning the NFC tag including scanning the NFC tag;
indicating the picture; and
matching or mismatching, and returning to the step of scanning the NFC tag when mismatching.
